(19) United States
(12) Patent Application Publication
(10) Pub. No.: US 2021/0073698 A1
(43) Pub. Date: Mar. 11, 2021

(54) Methods and Systems for Booking Resources and Access Management of Booked Resources

(71) Applicant: AIR STAYZ Pty Limited, Melbourne (AU)

(72) Inventors: Marc Adrian Italia, St Kilda (AU); Ajit Mann, St Kilda (AU); Marco Antonio Soriano, St Kilda (AU)

(73) Assignee: AIR STAYZ Pty Limited, Melbourne (AU)

(21) Appl. No.: 17/050,024

(22) PCT Filed: Apr. 24, 2019
(86) PCT No.: PCT/AU2019/050365

§ 371 Date: Oct. 23, 2020

(30) Foreign Application Priority Data
Apr. 24, 2018 (AU) 2018901365

(51) Int. Cl. G06Q 10/06; G07C 9/00; G06K 19/06; H04W 4/80

(52) U.S. Cl. CPC G06Q 10/06314; G06Q 10/06311; H04W 4/80; G06K 19/06037; G07C 9/00904

(57) ABSTRACT

A computer implemented method for booking a resource and providing access to the booked resource. The method is implemented on a resource management system configured to communicate with one or computing devices and one or more resource booking systems across a communications network. The method comprises receiving, at the resource management system, a request to book a resource from a computing device of the one or more computing devices, the request comprising a resource identifier and a mobile computing device identifier and creating a booking based on the resource identifier. The method further comprises determining a virtual key associated with the resource identifier, wherein the virtual key is configured to cooperate with an access device co-located with the resource to permit access to the resource; and providing a confirmation message to a mobile computing device of the one or more computing devices associated with the mobile computing device identifier, wherein the confirmation message comprises one of (i) the virtual key and (ii) a confirmation code related to the virtual key to allow the virtual key to be retrieved.

### CROSS-REFERENCE TO RELATED APPLICATIONS

This is a National Stage Application under 35 U.S.C. § 371 of PCT/AU2019/050365, filed on Apr. 24, 2019, which claims priority to Australian Patent Application having serial number 2018901365, filed on Apr. 24, 2018, which is incorporated by reference herein.

### TECHNICAL FIELD

Described embodiments relate to methods and systems for booking resources and access management of booked resources. Some embodiments relate to methods and systems for resource management, such as booking resources and providing access to the booked resources. Some embodiments relate to methods and systems for booking resources and accessing the booked resources. Some embodiments relate to methods and systems for managing access to booked resources.

### BACKGROUND

Booking and accessing of resources can be a time intensive and arduous process. For example, having booked accommodation in advance, in general patrons of hotels still need to undergo a check-in process at the hotel upon arriving. The check-in process is generally managed by staff at the hotel and may involve verification of identification and provision of key(s) for the booked rooms(s). Hotels may also have systems to manage and track the allocation of rooms and keys to customers checking in. Similar processes are performed when booking and accessing other types of resources, such as car rentals.

It is desired to address or ameliorate some of the disadvantages associated with prior methods and systems for hotel room booking and room access management, or at least to provide a useful alternative thereto.

Any discussion of documents, acts, materials, devices, articles or the like which has been included in the present specification is not to be taken as an admission that any or all of these matters form part of the prior art base or were common general knowledge in the field relevant to the present disclosure as it existed before the priority date of each of the appended claims.

### SUMMARY

Some embodiments relate to a computer implemented method for booking a resource and providing access to the booked resource, the method being implemented on a resource management system configured to communicate with one or computing devices and one or more resource booking systems across a communications network, the method comprising:

receiving, at the resource management system, a request to book a resource from a computing device of the one or more computing devices, the request comprising a resource identifier and a mobile computing device identifier;

creating a booking based on the resource identifier;

determining a virtual key associated with the resource identifier, wherein the virtual key is configured to cooperate with an access device co-located with the resource to permit access to the resource; and

providing a confirmation message to a mobile computing device of the one or more computing devices associated with the mobile computing device identifier, wherein the confirmation message comprises the virtual key.

In some embodiments, creating the booking comprises transmitting a booking confirmation request to the resource booking system to confirm the booking of the resource.

In some embodiments, determining the virtual key associated with the resource comprises retrieving the virtual key from a virtual key database based on the resource identifier.

In some embodiments, the virtual key comprises one or more QR codes readable by the access device associated with the resource identifier.

In some embodiments, the request further comprises one or more of: (i) payment details and (ii) an indication of a duration for the booking.

Some embodiments relate to a resource management system for booking resources and providing access to the booked resources, the system configured to communicate with one or computing devices and one or more resource booking systems across a communications network, the system comprising: one or more servers, each of the one or more servers comprising: one or more processors; and memory comprising computer code, which when executed by the one or more processors causes the one of more servers of the system to perform the method of for booking a resource and providing access to the booked resource.

Some embodiments relate to a computer implemented method for booking a resource and accessing the booked resource, the method implemented on a mobile computing device configured to communicate with a resource management system across a communications network, the method comprising: sending, from the mobile computing device, a request to book a resource to the resource management system, the request comprising a resource identifier and a mobile computing device identifier; receiving, at the mobile computing device, a confirmation message from the accommodation management server, the confirmation message comprising a virtual key associated with the booked accommodation, wherein the virtual key is configured to cooperate with an access device co-located with the resource to permit access to the resource; and providing the virtual key to the access device co-located with the resource to gain access the resource.

In some embodiments, providing the virtual key to the access device comprises one of (i) presenting the virtual key to a reader of the access device to allow the access device to scan the virtual key; and (ii) sending the virtual key to the access device using near field communication capability or Bluetooth based communication capability.

Some embodiments relate to a mobile computing device for booking resources and accessing booked resources, the device configured to communicate with a resource management system across a first communications network and one or more locking devices across a second communications network, the device comprising: one or more processors; and memory comprising computer code, which when executed by the one or more processors causes the mobile computing device to perform the method for booking resources and providing access to the booked resources.

Some embodiments relate to a method of permitting access to a booked resource, the method implemented by an access device configured to operate one or more locking mechanisms associated with a respective resource, the access device configured to communicate with one or more mobile devices over a communications network, the method comprising: receiving, at the access device, an access request from a mobile computing device of the one or more mobile computing devices, the access request comprising a virtual key for a resource co-located with the access device; determining a validity of the virtual key for the resource; responsive to determining that the virtual key is valid for the resource, activating a locking mechanism associated with the resource to permit access to the resource.

In some embodiments, determining the validity of the virtual key for the resource comprises comparing the virtual key with a stored virtual key for the resource and determining whether the virtual key is substantially equal to or different from the stored virtual key.

In some embodiments, determining the validity of the virtual key for the resource, comprises: sending, from the access device, validation information to a resource access monitoring system, wherein the validation information comprises the virtual key and a resource identifier associated with the resource; and receiving, at the access device, an notification indicating the validity or invalidity of the virtual key for the resource from the resource access monitoring system.

Some embodiments relate to an access device for permitting access to booked resources, the access device configured to operate one or more locking mechanisms associated with respective booked resources and to communicate with one or more mobile computing devices over a communications network, the access device comprising: one or more processors; and memory comprising computer code, which when executed by the one or more processors causes the mobile computing device to perform the method for booking resources and providing access to the booked resources.

Some embodiments relate to a resource booking and management system for booking resources and providing access to the booked resources, the system comprising: the resource management system of any one of the described embodiments; and one or more computing devices of any one of the described embodiments; and one or more access devices of any one of the described embodiments.

Some embodiments relate to a computer program product comprising computer readable code, which when executed by one or more processors is configured to perform any one of the described methods.

### BRIEF DESCRIPTION OF DRAWINGS

Some embodiments will now be described by way of non-limiting examples with reference to the accompanying drawings.

FIG. 1 is a block diagram of a system for booking and access management of booked resources, according to some embodiments;

FIG. 2 is a process flow diagram of a method of resource management according to some embodiments, the method being implemented by a resource management system of the system of FIG. 1;

FIG. 3 is a process flow diagram of a method of booking a resource and gaining access to the booked resource, according to some embodiments, the method being implemented by a mobile computing device of the system of FIG. 1;

FIG. 4 is a process flow diagram of a method of managing access to booked resources, according to some embodiments, the method being implemented by an access device of the system of FIG. 1;

FIGS. 5 and 6 are example screenshots of a booking management platform showing various stages involved in a booking process, according to some embodiments, the booking management platform being realised by a booking management application being executed by the resource management system of FIG. 1; and

FIGS. 6 and 7 are example screenshots of an interface displayed on a screen of a computing device of the system of FIG. 1.

### DESCRIPTION OF EMBODIMENTS

Described embodiments relate to methods and systems for booking resources and access management of booked resources. Some embodiments relate to methods and systems for resource management, such as booking resources and providing access to the booked resources. Some embodiments relate to methods and systems for booking resources and accessing the booked resources. Some embodiments relate to methods and systems for managing access to booked resources.

For example, resources according to described embodiments may relate to resources that may be booked and for which access is required for use or benefit of the resource. For example, resources may include rooms, such as hotel or hostel rooms, houses, flats, apartments, services facilities, such as gyms, vehicles, such as cars, bicycles, mopeds, motor bikes, or equipment, such as building equipment or gym equipment for example.

The described systems and methods for booking resources and accessing booked resources according to the described embodiments provide significant advantages over known prior art systems and methods. In particular, the described embodiments allow for streamlined booking of resources which enable users to both book resources and acquire means necessary for accessing the booked resources, for example, using a virtual key, in one relatively straight forward process. Virtual keys according to the described embodiments may be directly obtained from a booking platform when booking a resource, thereby minimizing or eliminating further additional steps in securing and gaining access to a resource once a booking has been made. Further virtual keys according to the described embodiments may not be lost and the expenses associated with replacement of lost physical keys or access cards may be avoided. The replacement of lost physical keys or access cards according to the prior art may have adverse environmental consequences that the described embodiments help avoid. Additionally, a single virtual key according to the described embodiments may be shared across more than one mobile computing device by replication, enabling the sharing of access to a resource between more than one user, each user holding a mobile computing device and accessing the booked resource independently of other users.

The streamlining of the process for booking of resources and management of access to booked resources also reduces human intervention necessary to facilitate booking and access. With reduced need for human intervention, the described systems and methods for booking resources and accessing booked resources may be more scalable in terms of handling a larger number of resources and bookings while providing a more efficient and low-latency service requiring less human intervention. Virtual key based access to booked resources may also provide improved identity based security for managing access to booked resources. For example, access through virtual keys on mobile computing device may enable tracking the identity of the mobile device along with the virtual key. In some embodiments, the combination of the virtual key and identity of the device may be verified to permit access to a booked resource as an extra layer of security.

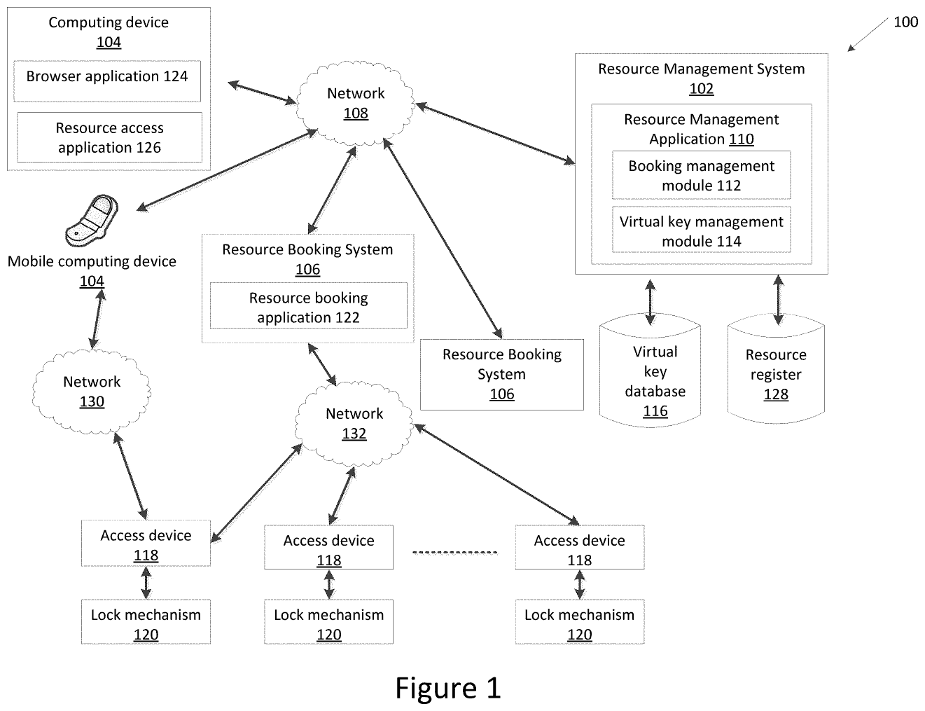

FIG. 1 illustrates a block diagram of a system 100 for booking and access management of booked resources, according to some embodiments.

As illustrated, the system 100 may comprise a resource management system 102 arranged to communicate with one or more computing devices 104 and one or more resource booking systems 106 across a communications network 108. In some embodiments, the system 100 comprises a client-server architecture where the resource management system 102 is configured as a server and at least one of the computing devices 104 is configured as a client computing device.

The network 108 may include, for example, at least a portion of one or more networks having one or more nodes that transmit, receive, forward, generate, buffer, store, route, switch, process, or a combination thereof, etc. one or more messages, packets, signals, some combination thereof, or so forth. The network 108 may include, for example, one or more of: a wireless network, a wired network, an internet, an intranet, a public network, a packet-switched network, a circuit-switched network, an ad hoc network, an infrastructure network, a public-switched telephone network (PSTN), a cable network, a cellular network, a satellite network, a fiber optic network, some combination thereof, or so forth.

In some embodiments, the computing device 104 may comprise a mobile or hand-held computing device such as a smartphone or tablet, a laptop, or a PC, and may, in some embodiments, comprise multiple computing devices.

The resource management system 102 may comprise one or more servers (not shown) configured to provide resource management services by executing a resource management application 110 stored in memory (not shown) associated with the one or more servers of the resource management system 102. For example, the resource management system 102 may include multiple processing components or multiple virtual or physical servers operating together. In some embodiments, the resource management application 110 may comprise a booking management module 112 and a virtual key management module 114.

The booking management module 112, when executed by one or more processors (not shown) of one or more servers (not shown) of the resource management system 102, may be configured to communicate with the resource booking system 106 across the communication network 108 to determine availability of resources associated with the resource booking system 106 and to book specific resources, for example, for a particular user and/or for a particular duration of time.

The virtual key management module 114, when executed by one or more processors (not shown) of the one or more servers (not shown) of the resource management system 102, may be configured to interrogate a virtual key database 116 to determine a virtual key for a specific resource. In some embodiments, the virtual key associated with a particular resource is configured to cooperate with an access device 118, which may be co-located with the resource, to provide access to the resource, for example, by causing the access device 118 to deactivate a locking mechanism 120 preventing access to the resource. The virtual key database 116 may form part of or be directly connected to the resource management system 102 or may be accessed by the resource management system 102 across communications network 108 or any other suitable network.

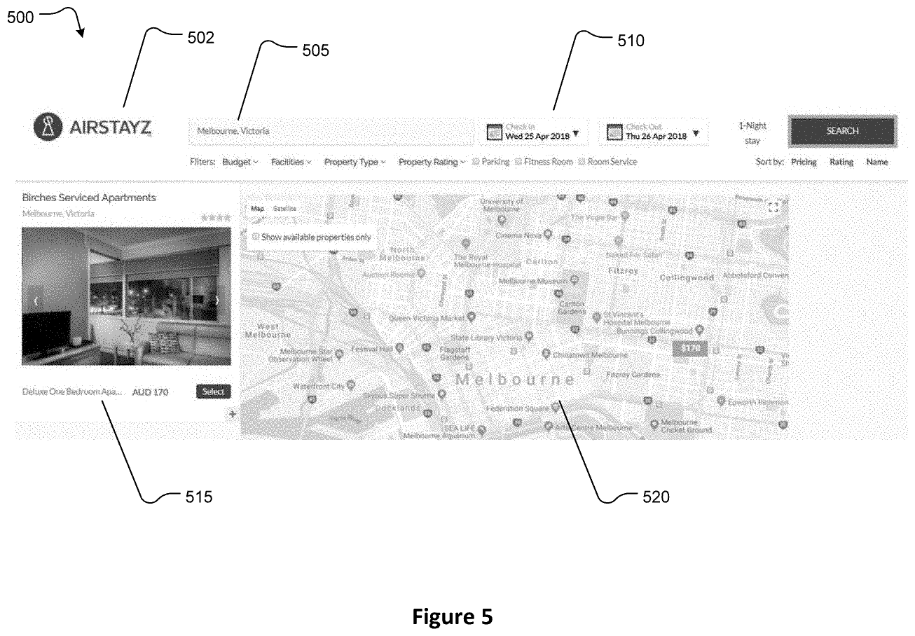

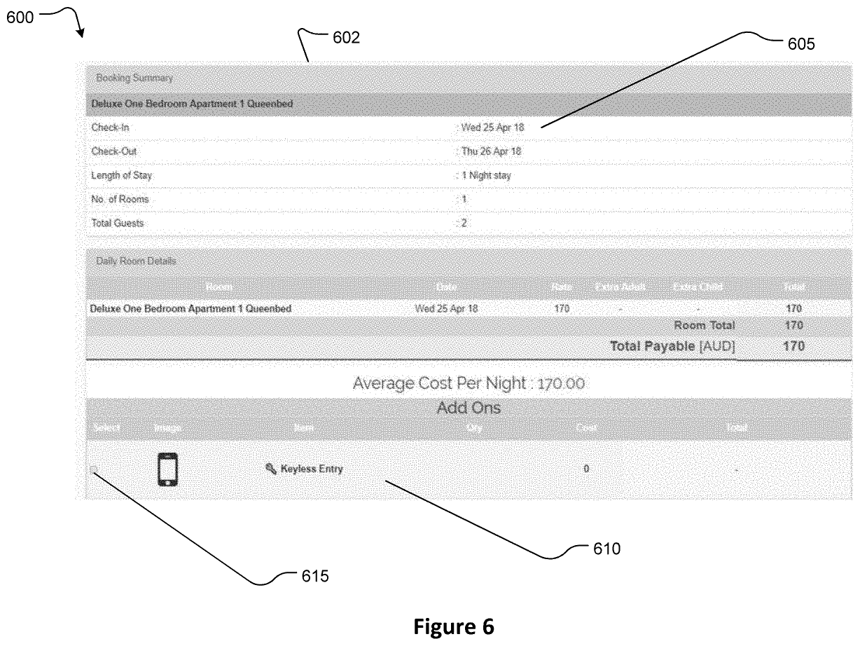

In some embodiments, the resource management system 102 may be configured as a web server system that is capable of serving content such as web pages and other content in accordance with a protocol such as the hypertext transfer protocol (HTTP). For example, when supported by and combined with an application framework and typical server-side functions, such as web server functions, data processing functions and data storage and retrieval function, the resource management application 110 provides a resource booking platform (an example of which is illustrated in FIGS. 5 and 6) which may encompass activities that may be viewed as being performed or executed at the one or more computing devices 104. However, it will be understood that activities performed or executed at the computing devices 104 are reliant on program code (including applets, where appropriate) served by the resource management system 102 to the computing devices 104 and executed by a browser application (not shown). The functionality of the booking platform is therefore driven by code executed and served by the resource management system 102.

The resource management application 110 may allow programmatic interaction of remote applications to exchange information with the resource booking system 106 via defined APIs (“application program interfaces”). The resource management services may be defined and implemented using a variety of underlying protocols and techniques. For example, some embodiments may rely on data communication in XML (“eXtensible Markup Language”) format using HTTP (“Hyper Text Transport Protocol”) in response to a request from the booking management module 112 specified as a URI (“Uniform Resource Identifier”), such as a URL (“Uniform Resource Locator”) that includes a specified operation and one or more query parameters. Such URI-based requests may, for example, be based on the use of XML over HTTP (e.g., as part of the Representational State Transfer, or “REST”, distributed interaction model). In some embodiments, additional underlying protocols may be used for various purposes, such as SOAP (“Simple Object Access Protocol”) for standard message exchange, WSDL (“Web Services Description Language”) for description of service invocations, and UDDI (“Universal Description, Discovery, and Integration service”) for discovery of available services.

The resource booking system 106 may comprise one or more servers (not shown) configured to provide a resource booking service by executing a resource booking application 122 stored in memory (not shown) associated with the one or more servers of the resource booking system 106. The resource booking system 106 is configured to maintain a register of resources available for booking through the resource booking system 106. The resource booking system 106 is further configured to provide or otherwise make available to the booking management module 112 of the resource management system 102 information about the availability of resources and to book a resource, i.e., to make resources unavailable for booking, in response to receiving a booking confirmation from the resource management system 102. It will, however, be appreciated, that resources may be booked with the resource booking system 106 in other ways, for example, by a computing device 104 communicating directly with the resource booking system 106 or an operator manually booking a resource in response to a request made by a person. In some embodiments, the resource booking system 106 may be configured to provide or otherwise make available to the virtual key management module 112 of the resource management system 102 information about the virtual keys associated with particular resources. In some embodiments, the resource booking system 106 may be configured to provide or otherwise make available to the resource access application 126 of the computing device 104 information about a booked resource, which may include, for example, credentials for accessing the booked resource.

The resource booking application 122 may allow programmatic interaction of remote applications to exchange information via defined APIs (“application program interfaces”). The resource booking application 122 may be defined and implemented using a variety of underlying protocols and techniques. For example, some embodiments may rely on data communication in XML (“eXtensible Markup Language”) format using HTTP (“Hyper Text Transport Protocol”) in response to a request from the resource access application 126 or the resource management application 110 specified as a URI (“Uniform Resource Identifier”), such as a URL (“Uniform Resource Locator”) that includes a specified operation and one or more query parameters. Such URI-based requests may, for example, be based on the use of XML over HTTP (e.g., as part of the Representational State Transfer, or “REST”, distributed interaction model). In some embodiments, additional underlying protocols may be used for various purposes, such as SOAP (“Simple Object Access Protocol”) for standard message exchange, WSDL (“Web Services Description Language”) for description of service invocations, and UDDI (“Universal Description, Discovery, and Integration service”) for discovery of available services.

The one or more computing devices 104 each comprise one or more processors (not shown) and memory (not shown) which includes an operating system and a number of software applications or applets executable by the one or more processors to perform various device-related functions. For example, at least one such software application includes a browser application 124 for enabling a user to navigate to sites accessible over the communications network 108 to receive content therefrom. In some examples, the browser application 124 can be used to communicate with the resource management system 102 to request content therefrom, in the form of one or more web pages provided as program code to the browser application and executable by the processor(s) of the computing device 102. According to some embodiments, the resource management system 102 is configured to serve code to the computing device 104 to provide an online resource booking platform generated by browser application 124 and viewable on a display (not shown) of a user interface (not shown) of the computing device 104.

The resource booking platform may provide user interfaces that allow a user to search for resources using particular key terms and/or criteria. For example, where the resource to be booked is a hotel room, the resource booking platform may provide user interfaces that allow a user to enter specific location(s) and/or specific date(s) to search for an available hotel room meeting the search criteria. In response to user inputting search criteria, the booking management module 112 of the resource management application 110 may determine and provide to the resource booking platform a list of available hotels. The resource booking platform may allow the user to navigate through the results and to select a particular hotel. Upon selecting a particular hotel, the user may be prompted to make a payment for the hotel booking, for example, by providing payment details. During the booking process, the user may also be queried as to whether he or she would like to avail of keyless entry to the hotel room, as discussed below in more detail.

In some embodiments, the browser application 124 may be supplemented by a special-purpose add-on or may be substituted by special-purpose client software (i.e. an “app” for a smart-phone or tablet device) in order to perform the functions described herein or to facilitate such functions. For example, for the computing device 104, a special purpose application may be downloaded from the resource management system 102 or a separate dedicated download server (not shown) and installed on the computing device 104. When such a special purpose application is executing on the computing devices 104, it may facilitate appropriate formatting, interaction, display and input to enable the user interface functionality described herein. Such a special purpose application may comprise a resource access application 126 configured to cooperate with application software running on the access device 118. In some embodiments, the resource access application 126 is configured to receive and store a virtual key associated with a particular resource, from for example, the resource management system 102, and to provide the virtual key to the access device 118 associated with the resource to deactivate a locking mechanism 120 preventing access to the resource.

The resource access application 126 may be configured to communicate with the resource management system 102 to request and/or receive information from the resource management system 102. In some embodiments, the resource access application 126 is configured to receive and store a virtual key associated with a particular resource, from the resource management system 102, for example, and to provide the virtual key to the access device 118 associated with the resource to deactivate a locking mechanism 120 preventing access to the resource. In some embodiments, the resource access application 126 is configured to receive and store booking confirmation details associated with a booked resource, for example, a resource identifier, relevant dates, payment confirmation details, etc.

The access devices 118 are configured to communicate with the resource access application 126 of the mobile computing device 104 to determine a virtual key associated with a particular resource that is being managed under the control of the access device 118. For example, the resource access application 126 of the mobile computing device 104 may be configured to communicate with the access device 118 using near field communication capability or Bluetooth based communication capability. In some embodiments, the virtual key may comprise a QR codes which is readable or scannable by the access device 118.

The access devices 118 are each associated with one or more resources and a respective one or more locking mechanisms 120. When activated by the access device 118, or otherwise, the locking mechanisms 120 prevent access to the respective resource. In some embodiments, the access devices 118 comprise one or more processors and memory comprising computing code, which when executed by the one or more processors is configured to control operations of the access device 118. For example, the access device 118 may be configured to determine a virtual key provided on or received from a mobile computing device 104, determine a validity of the virtual key for a particular resource and in response to determining that the virtual key is valid for that resource, deactivate a locking mechanism 120 associated with the resource to allow access to the resource. In some embodiments, the access devices 118 are configured to communicate with the resource booking system 106 or other servers (not shown) associated with the management of the resources to determine the validity of a virtual key for a particular resource. For example, the resource booking system 106 or other servers (not shown) may query a register of virtual keys for resources and compare the virtual key for the resource to an entry in the register to determine its validity, for example, by determining whether a booking has been made and the virtual key is active, and/or whether the virtual key matches records in the register for the particular resource.

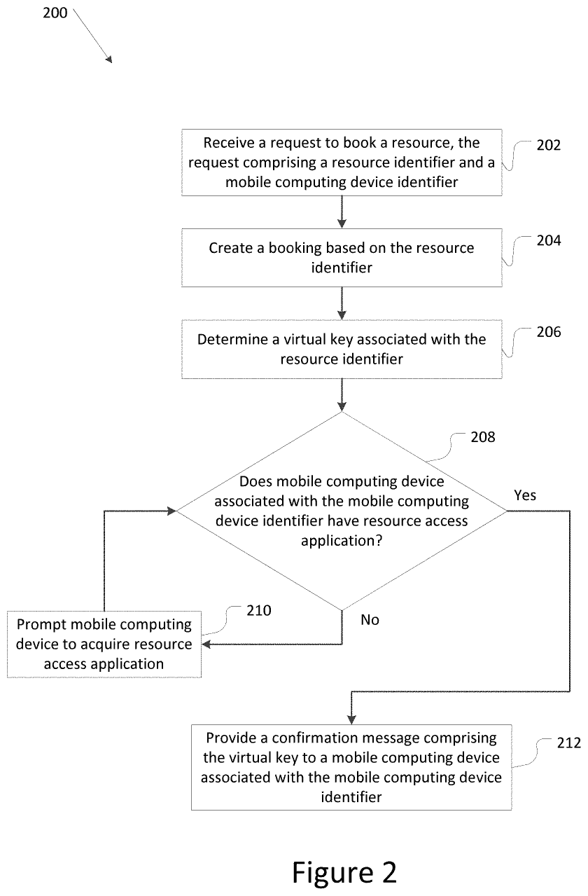

FIG. 2 is a process flow diagram of a method 200 of resource management according to some embodiments. The method 200 may be implemented by a resource management system 102. In particular, one or more processors of the resource management system 102 may be configured to execute the resource management application 110 to cause the resource management system 102 to perform the method 200.

Referring now to FIG. 2, a request to book a resource is received at the resource management system 102 from a computing device 104, at 202. The request comprises a resource identifier and a mobile computing device identifier. In some embodiments, the request further includes one or more of an indication of a duration for booking of the resource, any particular special requests and payment details.

In some embodiments, the resource management application 110 is configured to retrieve details of resources in response to a query received from the computing device 104 and to display the details on the booking platform to allow a user to select a resource and to submit the request for a booking. In some embodiments, the booking management module 112 determines whether resources are available and any further details about the resources from a resource register 128 which may be local to or remote from the resource management system 102, and which is periodically and/or regularly updated by one or more resource booking systems 106 associated with the resources. In some embodiments, the booking management module 112 determines whether resources are available and any further details about the resources by querying one or more resource booking system 106.

For example, a resource information query may be initiated by the booking management module 112 submitting a HTTP POST request to a designated URL of the resource booking application 122 in an XML format. The resource information query may also include credentials to validate and authorize the booking of the resource by the resource booking application 122. Below is an example of a HTTP POST request in XML format:

<gethotels>

<usertoken>
<userid>xxxx</userid>
<password>yyyy</password>
</usertoken>

</gethotels>

The resource booking application 122 may return a response to the query above in the following format:

<?xml version=“1.0” encoding=“utf-8” ?>
<hotels>

<hotel>
<hotelid>1</hotelid>
<hotelname>test-hotel-1</hotelname>
</hotel>

</hotels>

The booking management module 112 may further query the resource booking application 122 for details of available resources with particular criteria, for example, available resources in particular locations. Below is an example of a query for hotel room types for a hotel with hotel id 71656:

<getroomtypes>

<usertoken>
<userid>xxxx</userid>
<password>yyyy</password>
<hotelid>71656</hotelid>
</usertoken>

</getroomtypes>

An example of response generated by the resource booking application 122 to the above query may be in the following format:

<?xml version=“1.0” encoding=“utf-8” ?>

<roomtypes>
<roomtype>

<id>142790</id>
<description>standard</description>

</roomtype>
<roomtype>

<id>145612</id>

<description>2 bedroom apartment</description>

</roomtype>
<roomtype>

<id>148227</id>
<description>superior</description>

</roomtype>
<roomtype>

<id>97356</id>
<description>deluxe</description>

</roomtype>
</roomtypes>

A user at the computing device 104 may navigate the details of the resources displayed on the booking platform and select a resource and cause the request to book the associated resource to be sent to the resource management system 102.

Referring again to FIG. 2, the resource management system 102, and in particular, the booking management module 112, creates a booking based on the resource identifier, at 204. In some embodiments, the booking management module 112 transmits a booking confirmation request to the resource booking application 122 of the resource booking system. The booking confirmation request comprises the resource identifier and may further include additional information about the booking.

Below is an example of a booking confirmation request being sent to the resource booking application 122 by the booking management module 112:

<booking>

<username>xxxxxx</username>
<password>yyyyy</password>
<bookingtime>2010-11-22 18:37:48</bookingtime>
<bookingid>3345</bookingid>
<bookingstatus>Confirmed</bookingstatus>
<hotelname>third party site hotel</hotelname>
<hotelid>4</hotelid>
<arrivaldate>2010-11-24</arrivaldate>
<departuredate>2010-11-30</departuredate>
<currencycode>aud</currencycode>
<totalcost>620.00</totalcost>
<roomid>6</roomid>
<roomquantity>1</roomquantity>
<guestcount>2</guestcount>
<arrivaltime>02:00</arrivaltime>
<guestname>guest</guestname>
<guestphone>+64-9-123456</guestphone>
<guestemail>admin@myproperties.com</guestemail>
<specialrequest>Test </specialrequest>
<deposit>0</deposit>
<depositdescription></depositdescription>
<refer></refer>
<addons>

<addon>
<id>1</id>
<name>breakfast</name>
<unitcost>10</unitcost>
<quantity>2</quantity>
<total>100</total>
<nights>5</nights>
</addon>
<addon>

<id>2</id>
<name>box of chocolate on arrival</name>
<unitcost>20</unitcost>
<quantity>1</quantity>
<total>20</total>
<nights>-</nights>

</addon>

<addontotal>120</addontotal>
</addons>

</booking>

In some embodiments, the resource booking application 122 determines whether to confirm or deny the booking confirmation request and sends a response to the booking management module 112. In some embodiments, if the resource booking application 122 confirms the booking, the resource booking application 122 may update a resource register to reflect the booking and, for example, to mitigate multiple bookings for the same periods for the same resource being made. In some embodiments, the booking management module 112 updates details about the resource in the resource register 128.

The resource management application 110, and in particular, the virtual key management module 114, determines a virtual key for the booked resource, at 206. In some embodiments, the virtual key management module 114 queries a virtual key database 116 using the resource identifier to determine the virtual key associated with the resource identified by the resource identifier.

In some embodiments, the resource management application 110 determines whether a mobile computing device 204 associated with the mobile computing device identifier has a resource access application 126 deployed thereon, at 208. For example, the resource management application 110 may query a resource access application register (not shown) using information about the user or the mobile computing device, such as the mobile computing device identifier, to determine whether the resource access application 126 has been downloaded to the mobile computing device 204 associated with the user, such as the mobile computing device identified by the mobile computing device identifier. In some embodiments, the resource management application 110 may send a query to the computing device 104 to determine if the resource access application 126 is deployed thereon. If it is determined that the resource access application 126 is not deployed on the mobile computing device 104, the resource management application 110 prompts the computing device 104, for example, by way of sending a link to download the resource access application 126, to obtain the resource access application 126, at 210, and the method reverts to 208.

If it is determined that the resource access application 126 is deployed on the mobile computing device 104, the resource management application 110 provides a confirmation message comprising the virtual key associated with the booked resource to the mobile computing device 104 associated with the mobile computing device identifier, at 212. In some embodiments, as opposed to providing the virtual key directly to the mobile computing device via the confirmation message, the virtual key may be provided indirectly to the mobile computing device, for example, by providing a confirmation code relating to the virtual key as opposed to the virtual key in the confirmation message. In embodiments where a confirmation code relating to a virtual key is provided, the confirmation code may be used to retrieve and download the related virtual key to the mobile computing device 104, for example, from a website, an address of which may be provided in the confirmation message.

In some embodiments, the resource management application 110 does not determine whether a mobile computing device 204 associated with the mobile computing device identifier has a resource access application 126 deployed thereon and instead either provides a confirmation message comprising the virtual key associated with the booked resource to the mobile computing device 104 associated with the mobile computing device identifier, as at 212, or provides a confirmation message comprising a confirmation code relating to the virtual key associated with the booked resource to the mobile computing device 104 associated with the mobile computing device identifier. For example, in some cases, it may be unnecessary for the mobile computing device 204 to have a resource management application 110 to receive and use a virtual key to access a resource. In embodiments where a confirmation code relating to a virtual key is provided, the confirmation code may be used to retrieve and download the related virtual key to the mobile computing device 104, for example, from a website, an address of which may be provided in the confirmation message.

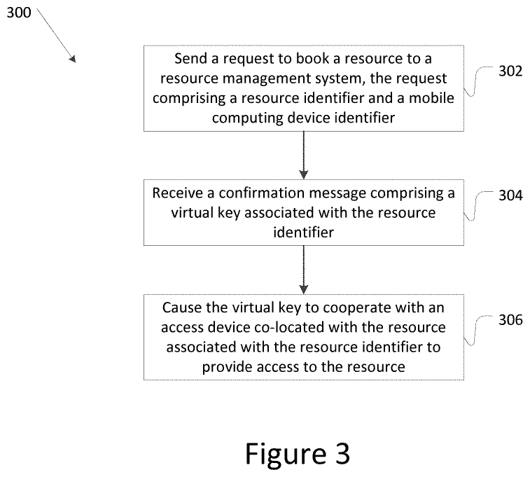

FIG. 3 is a process flow diagram of a method 300 of booking a resource and gaining access to the booked resource, according to some embodiments. The method 300 may be implemented by a mobile computing device 104. In particular, one or more processors of the computing device 104 may be configured to execute the browser application 124 and the resource access application to cause the computing device 102 to perform the method 300.

A request to book a resource is sent from the computing device 104 to the resource management system 102, at 302. As described above, the computing device 204 is configured to display a booking platform to the user to allow the user to generate the request to book the resource. The request comprises a resource identifier associated with the resource to be booked and a mobile computing device identifier. In some embodiments, the mobile computing device identifier may be an identifier of the computing device 104, such as a phone number.

A confirmation message comprising a virtual key is received at the mobile computing device 104 associated with the mobile computing device identifier, at 304. In some embodiments, instead of a virtual key, the confirmation message may comprise a confirmation code relating to the virtual key. The confirmation code may be used to retrieve and download the related virtual key thereafter.

The virtual key is used to gain access to the booked resource. The virtual key is caused to cooperate with an access device 118 associated with the booked resource to provide access to the resource, at 306. In some embodiments, the resource access application 126 is configured to communicate with the access device 118 to gain access to the resource. Responsive to the access device 118 determining that the virtual key is valid for the particular resource, the virtual key provides access to the resource.

The resource access application 126 using the virtual key may be configured to communicate with the access device using near field communication (NFC) capability or Bluetooth based communication capability. In some embodiments, the virtual key may comprise a QR codes which is readable or scannable by the access device 118.

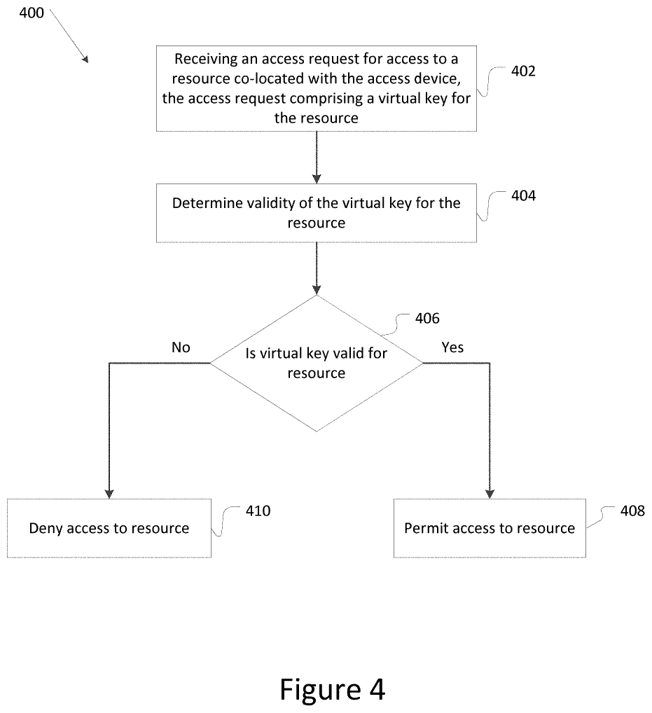

FIG. 4 is a process flow diagram of a method 400 of managing access to booked resources, according to some embodiments. The method may be implemented by an access device 118 of the system 100. In particular, one or more processors of the access device 118 may be configured to execute instructions (computer code) to cause the access device 118 to perform the method 400.

An access request for access to a resource co-located or otherwise associated with an access device 118 is received from a mobile computing device 104 at the access device 118, at 402. For example, the access request may be received from a resource access application 126 deployed on the mobile computing device 104. The access request comprises a virtual key associated with the resource. In some embodiments, the access request further comprises a resource identifier associated with the resource and the virtual key.

Validity of the virtual key for a particular resource is determined, at 404. In some embodiments, the access device 118 communicates with the resource booking system 106 or other servers (not shown) associated with the management of the resources to determine the validity of a virtual key for a particular resource. In some embodiments, relevant validity information may be stored locally in memory of the access device 118 and interrogated to determine the validity of the presented virtual key for the resource. Validity of the virtual key may depend on the date and time at which the access request was received.

In some embodiments, the access device 118 may cause the resource access application 126 to prompt the user to undertake certain identification verification or compliance steps before granting access to the resource. For example, in some embodiments, the resource access application 126 may prompt the user to provide documentation such as a proof of identification. The documentation may be communicated by the resource access application 126 to the resource booking system 106 or other relevant sever or system (not shown) for example, for record keeping purposes.

If it is determined that the virtual key is valid for the resource, at 406, access to the resource is permitted, at 410. For example, in some embodiments, the access device 118 communicates with a respective locking mechanism 120, directly or via a communications network (not shown), to deactivate the locking mechanism 120 and provide access to the resource.

If it is determined that the virtual key is not valid for the resource, at 406, access to the resource is denied, at 410. In some embodiments, the access device 118 may report to the resource booking system 106 or other associated server or system a denial of entry with the details of the presented virtual key or credential. This may assist in monitoring attempts of unauthorised entry.

FIG. 5 illustrates an example screenshot 500 of a booking platform for a hotel resource as shown on an interface of a computing device 104. Region 505 allows the user to enter a desired destination to search for hotels. Through user selectable options shown at regions 510, the user may enter the relevant check-in and check-out dates. A list of all the hotels available according to the criterion entered by the user is displayed in a display window 515. A map view of the identified hotels is shown at map view window 520.

FIG. 6 illustrates another example screenshot 600 of a booking platform 602 for a hotel resource as shown on an interface of a computing device 104. Region 605 of the booking platform 602 displays details of a booking made by a user. In particular, check-in and check-out dates, number of guests and rooms are displayed for confirmation and review by the user. Section 610 of the booking platform 602 displays relevant add-ons applicable to the booking. One relevant add on is the ability to make a keyless entry to the hotel room. By selecting a user selectable option 615, the user may indicate his or her interest in seeking keyless entry to the booked hotel room upon arrival.

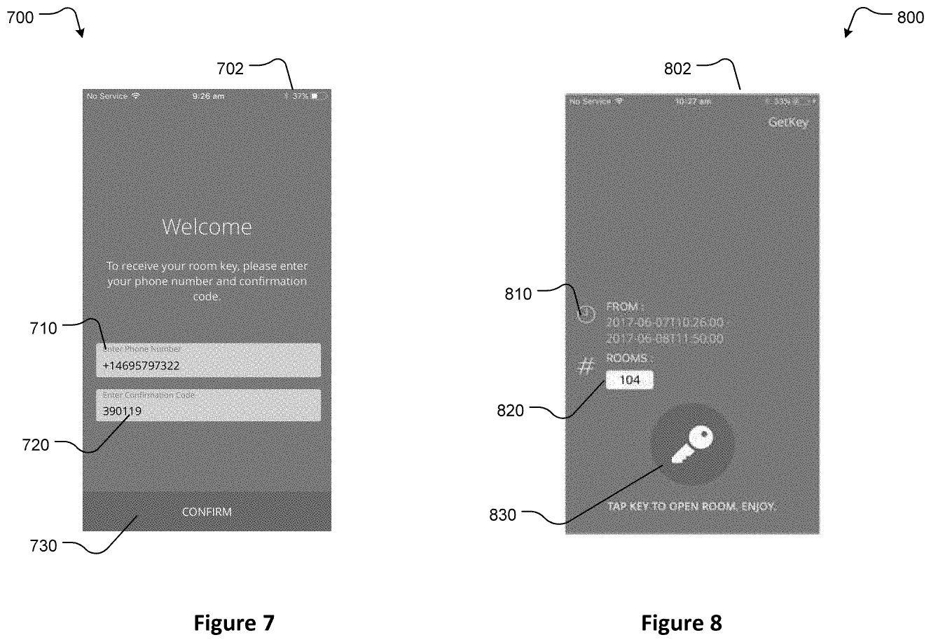

FIG. 7 illustrates an example screenshot 700 of an interface 702 of the resource access application 126, which may for example, be presented to the user when activating the resource access application 126 for a first time. The user is prompted to enter his or her phone number in region 710 and a confirmation code by the user in region 720. For example, the phone number entered by the user may correspond with the mobile computing device identified provided to the resource management system 102 at 302 of method 300 as shown in FIG. 3. The confirmation code may be provided to the user's computing device 104 when the resource access application 126 is downloaded or installed on the computing device 104. The confirmation code may be provided to the user's computing device 104 through a messaging service such as an SMS or an MMS or an email. After entering the phone number and confirmation code in interface 700, the user may confirm the details entered using a confirm button 730. After the user presses the confirm button 730, the entered details are communicated by the resource access application 126 to the resource booking system 106 to retrieve information pertinent to the booked resource. The resource management system 102 may also return to the resource access application 126, details of the user's booking, as illustrated in FIG. 8.

FIG. 8 illustrates an example screenshot 800 of an interface 802 of the resource access application 126. The interface 802 displays details of a confirmed hotel room booking allowing for validation by the user of received booking information. For example, region 810 displays the relevant dates for which the booking is valid, and region 820 displays the allocated room number to the booking. In some embodiments, the room number may not be allocated immediately after a booking and there may be an intervening period between the making of a booking by the user and allocation of a room to the booking made by the user. The interface 802 also provides a button 830 associated with a virtual key for the booked resource. Pressing the button 830 while placing the mobile computing device 104 in a vicinity of the access device 118, which, in this case may be a hotel door lock device, initiates transmission of the virtual key or credential details to the access device 118 for verification. For example, this may correspond with 306 of method 300 as shown in FIG. 3.

In some embodiments, the resource access application 126 may allow the sharing of the virtual key or credential across multiple mobile devices 104, each device executing the resource access application 126. The mobile device 104 registered during the booking process may be known as a primary mobile device. The primary mobile device, through the resource access application may share the received virtual key or credentials to other secondary mobile devices executing the resource access application. This may be advantageous where multiple people are to avail of the booked resource or multiple booked resources are associated with the same virtual key.

It will be appreciated by persons skilled in the art that numerous variations and/or modifications may be made to the above-described embodiments, without departing from the broad general scope of the present disclosure. The present embodiments are, therefore, to be considered in all respects as illustrative and not restrictive.

1. A computer implemented method for booking a resource and providing access to the booked resource, the method being implemented on a resource management system configured to communicate with one or computing devices and one or more resource booking systems across a communications network, the method comprising:
receiving, at the resource management system, a request to book a resource from a computing device of the one or more computing devices, the request comprising a resource identifier and a mobile computing device identifier;
creating a booking based on the resource identifier;
determining a virtual key associated with the resource identifier, wherein the virtual key is configured to cooperate with an access device co-located with the resource to permit access to the resource; and
providing a confirmation message to a mobile computing device of the one or more computing devices associated with the mobile computing device identifier, wherein the confirmation message comprises one of (i) the virtual key and (ii) a confirmation code related to the virtual key to allow the virtual key to be retrieved.

2. The method of claim 1, wherein creating the booking comprises transmitting a booking confirmation request to the resource booking system to confirm the booking of the resource.

3. The method of claim 1, wherein determining the virtual key associated with the resource comprises retrieving the virtual key from a virtual key database based on the resource identifier.

4. The method of claim 1, wherein the virtual key comprises one or more QR codes readable by the access device associated with the resource identifier.

5. The method of claim 1, wherein the request further comprises one or more of: (i) payment details and (ii) an indication of a duration for the booking.

6. A resource management system for booking resources and providing access to the booked resources, the system configured to communicate with one or computing devices and one or more resource booking systems across a communications network, the system comprising:
one or more servers, each of the one or more servers comprising:
one or more processors; and
memory comprising computer code, which when executed by the one or more processors causes the one of more servers of the system to perform the method of claim 1.

7. A computer implemented method for booking a resource and accessing the booked resource, the method implemented on a mobile computing device configured to communicate with a resource management system across a communications network, the method comprising:
sending, from the mobile computing device, a request to book a resource to the resource management system, the request comprising a resource identifier and a mobile computing device identifier;
receiving, at the mobile computing device, a confirmation message from the accommodation management server, the confirmation message comprising one of (i) a virtual key associated with the booked accommodation and (ii) a confirmation code related to the virtual key to allow the virtual key to be retrieved, wherein the virtual key is configured to cooperate with an access device co-located with the resource to permit access to the resource; and
providing the virtual key to the access device co-located with the resource to gain access the resource.

8. The method of claim 7, wherein providing the virtual key to the access device comprises one of (i) presenting the virtual key to a reader of the access device to allow the access device to scan the virtual key; and (ii) sending the virtual key to the access device using near field communication capability or Bluetooth based communication capability.

9. A mobile computing device for booking resources and accessing booked resources, the device configured to communicate with a resource management system across a first communications network and one or more locking devices across a second communications network, the device comprising:
one or more processors; and
memory comprising computer code, which when executed by the one or more processors causes the mobile computing device to perform the method of claim 6.

10. A method of permitting access to a booked resource, the method implemented by an access device configured to operate one or more locking mechanisms associated with a respective resource, the access device configured to communicate with one or more mobile devices over a communications network, the method comprising:
receiving, at the access device, an access request from a mobile computing device of the one or more mobile computing devices, the access request comprising a virtual key for a resource co-located with the access device;
determining a validity of the virtual key for the resource;
responsive to determining that the virtual key is valid for the resource, activating a locking mechanism associated with the resource to permit access to the resource.

11. The method of claim 10, wherein determining the validity of the virtual key for the resource comprises comparing the virtual key with a stored virtual key for the resource and determining whether the virtual key is substantially equal to or different from the stored virtual key.

12. The method of claim 10, wherein determining the validity of the virtual key for the resource, comprises:
sending, from the access device, validation information to a resource access monitoring system, wherein the validation information comprises the virtual key and a resource identifier associated with the resource; and
receiving, at the access device, an notification indicating the validity or invalidity of the virtual key for the resource from the resource access monitoring system.

13. An access device for permitting access to booked resources, the access device configured to operate one or more locking mechanisms associated with respective booked resources and to communicate with one or more mobile computing devices over a communications network, the access device comprising:
one or more processors; and
memory comprising computer code, which when executed by the one or more processors causes the mobile computing device to perform the method of claim 10.

14. (canceled)

15. A computer program product comprising computer readable code, which when executed by one or more processors is configured to perform the method of claim 1.
